(19) United States
(12) Patent Application Publication
(10) Pub. No.: US 2004/0151111 A1
(43) Pub. Date: Aug. 5, 2004

(54) Resource pooling in an Internet Protocol-based communication system

(76) Inventors: La Monte Yarroll, Palatine, IL (US); Qiaobing Xie, Wheeling, IL (US)

Correspondence Address: MOTOROLA, INC., 1303 EAST ALGONQUIN ROAD, IL01/3RD, SCHAUMBURG, IL, 60196

(21) Appl. No.: 10/355,480

(22) Filed: Jan. 31, 2003

(51) Int. Cl. H04J 1/16

(52) U.S. Cl. 370/216

(57) ABSTRACT

A ENRP server receives registration information from each of a first pool element (PE) and a second PE, wherein the registration information received from each PE includes a same pool handle. The registration information from the first PE further includes a redundancy model. The ENRP server creates a pool that includes both the first and second PEs and adopts, for the pool, the received redundancy model. A pool user (PU) may then access the pool by conveying the pool handle to the ENRP server, and, in response, receiving transport addresses corresponding to the PEs and the redundancy model implemented by the pool. The PU can then access the pool based on the received transport addresses and, when appropriate, the received redundancy model.

### FIELD OF THE INVENTION

The present invention relates generally to Internet Protocol-based communication systems, and, in particular, to resource pooling in an Internet Protocol-based communication system.

### BACKGROUND OF THE INVENTION

System availability is an important aspect of all communication systems. That is, a goal of every communication system is to achieve high availability so that if a part of the system crashes then the system is still able to provide service. One means of achieving high availability is to provide system redundancy. Redundancy comprises providing a backup system for an active system, so that if the active system crashes then the backup system can step in and perform the functions that were being performed by the active system.

A drawback to redundancy is a cost of a backup system. It is expensive to provide a backup system that may sit idle until the active system crashes. One way to better afford the costs of redundancy is to “pool” resources. “Pooling” involves bundling multiple resources that perform similar functions together into a pool so that a pool user (PU) may utilize any one or more of the pooled resources. When one resource in the pool, that is, a pool element (PE), fails, another PE, typically a backup or standby PE, can take over for the failed PE with a minimal interruption of service to the PU. The technique of switching from a failed active PE to a standby PE is known as fail-over.

In an Internet Protocol (IP) environment, application processors, such as processors running on web-based servers, that each provides a specific service to an application, may be pooled. Each such application processor is functionally identical to the other pool elements (PEs), that is, application processors, and provides a specific service to an application. The pooling of PEs is transparent to an application running on top of the pool, that is, all of the PEs appear to be a single element to the application. By pooling the PEs, system costs may be reduced since off-the-shelf components may be coupled together into a pool and the same service may be obtained as is obtained by use of a considerably more expensive computer. Furthermore, by pooling PEs, when a PE crashes only that PE must be replaced rather than replacing the entire system.

From another perspective, pooling involves a bundling of elements at protocol layers below an application layer in a manner that is transparent to the application layer. The application layer is the highest layer in a four layer protocol stack commonly used for the interconnection of Internet Protocol (IP)-based network systems. From highest to lowest the stack includes an application layer, a transport layer, a network layer, and a physical layer. The protocols specify the manner of interpreting each data bit of a data packet exchanged across the network. Protocol layering divides the network design into functional layers and then assigns separate protocols to perform each layer's task. By using protocol layering, the protocols are kept simple, each with a few well-defined tasks. The protocols can then be assembled into a useful whole, and individual protocols can be removed or replaced as needed. In a system that uses pooling, the application layer does not know the complexity of the lower layers, so that the lower layers may be organized in any fashion and may be easily replaced. As a result, the application layer may be more concerned with the quality of service provided to the application layer than the manner in which the service is implemented.

In order to provide high availability to the application layer, several models have been developed for implementing redundancy in a communication system. One such model is an ‘N+1’ redundancy model, wherein ‘N’ active servers share a node and one server is set aside as a backup. If one of the ‘N’ servers crashes, the backup steps in to take its place. Another such model is an ‘N+M’ redundancy model, wherein ‘N’ active servers share a node and ‘M’ servers are set aside as backups. Yet another such model is an ‘M pair’ redundancy model, wherein ‘2×M’ servers are paired up into ‘M’ pairs, each pair comprising an active and a backup server. If an active server crashes, the backup server of the pair fills in. If the backup crashes, it is not replaced. Each model has advantages and disadvantages. An advantage of the ‘M pair’ model is that each backup knows that state of its corresponding active, reducing the complexity of the system design. In the ‘N+1’ and ‘N+M’ redundancy models, each backup must know the states of all of the actives so that it can fill in for the active without a user noticing, and such state sharing is very expensive. However, the ‘M pair’ model may idle a greater quantity of resources when the system is failure free. Accordingly, one may want to leave the weighing of the costs and benefits of each redundancy model, and the decision of which redundancy model to implement, up to a system designer. Furthermore, one may want to permit a communication system to dynamically implement redundancy models. For example, instead of being locked into a single redundancy model for all pools in the system, it may be desirable to establish redundancy models on a pool-by-pool basis.

Currently, the standards for Internet Protocol (IP) communication systems only support a single redundancy model, wherein each PE in a pool is a backup of all other PEs in the pool. This redundancy model is extremely expensive to implement, is sub-optimal in many circumstances, and is very confining for system design.

Therefore, a need exists for a method and an apparatus that supports an implementation of multiple redundancy models and further supports a dynamic implementation of redundancy models in an IP communication system.

### BRIEF DESCRIPTION OF THE DRAWINGS

FIG. 1 is a block diagram of a communication system in accordance with an embodiment of the present invention.

FIG. 2 is a block diagram of a protocol stack in accordance with an embodiment of the present invention.

FIG. 3 is a logic flow diagram of a pool element registration process in accordance with an embodiment of the present invention.

FIG. 4 is a block diagram of a pool element registration message in accordance with an embodiment of the present invention.

FIG. 5A is a logic flow diagram of a method by which a pool user of FIG. 1 can access services provided by a pool of FIG. 1 in accordance with an embodiment of the present invention.

FIG. 5B is a continuation of the logic flow diagram of FIG. 5A of a method by which a pool user of FIG. 1 can access services provided by a pool of FIG. 1 in accordance with an embodiment of the present invention.

FIG. 6 is a block diagram of a pool handle translation request in accordance with an embodiment of the present invention.

FIG. 7 is a block diagram of a pool handle translation response in accordance with an embodiment of the present invention.

FIG. 8 is a logic flow diagram of a method by which the communication system of FIG. 1 in determines an alternate pool element for a pool user in accordance with an embodiment of the present invention.

### DETAILED DESCRIPTION OF THE INVENTION

To address the need for a method and an apparatus that supports an implementation of multiple redundancy models and further supports a dynamic implementation of redundancy models in an IP communication system, an ENRP server in an IP-based communication system receives registration information from each of a first pool element (PE) and a second PE, wherein the registration information received from each PE includes a same pool handle. The registration information from the first PE further includes a redundancy model. The ENRP server creates a pool that includes both the first and second PEs and adopts the redundancy model. A pool user (PU) may then access the pool by conveying the pool handle to the ENRP server, and, in response, receiving transport addresses corresponding to the PEs and the redundancy model adopted for the pool. The PU can then access the pool based on the received transport addresses and, when appropriate, the redundancy model.

Generally, an embodiment of the present invention encompasses a method for for pooling resources in an Internet Protocol-based communication system. The method includes receiving first registration information from a first pool element, wherein the registration information includes a pool handle and a redundancy model, and receiving second registration information from a second pool element, wherein the second registration information includes a same pool handle as the first registration information. The method further includes creating a pool that comprises the first pool element and the second pool element, wherein the creating of the pool comprises adopting, for the pool, the received redundancy model.

Another embodiment of the present invention encompasses a method for accessing pooled resources in an Internet Protocol-based communication system. The method includes assembling a data packet intended for a pool handle, requesting a translation of the pool handle from a name server, and, in response to the request, receiving multiple transport addresses and a redundancy model corresponding to the pool handle. The method further includes storing the received multiple transport addresses and the received redundancy model, selecting a transport address from among the multiple transport addresses to produce a selected transport address, and conveying the data packet to the selected transport address.

Yet another embodiment of the present invention encompasses a method for determining an alternate pool element from among multiple pool elements. The method comprises steps of detecting a transport failure in regard to a communication with a pool element of the multiple pool elements, determining a backup pool element based on a designation of a backup pool element from among the multiple pool elements, and determining a service status of the designated backup pool element. The method further comprises, subsequent to the detection of the transport failure and when the designated backup pool element is in-service, conveying data packets to the designated backup pool element; and subsequent to the detection of the transport failure and when the designated backup pool element is out-of-service, determining a backup pool element based on a redundancy model and conveying data packets to the backup pool element that is determined based on the redundancy model.

Still another embodiment of the present invention encompasses a name server capable of operating in an Internet Protocol-based communication system. The name server includes a processor coupled to at least one memory device. The processor is capable of receiving first registration information from a first pool element, wherein the registration information includes a pool handle, a first pool element identifier, and a redundancy model, receiving second registration information from a second pool element, wherein the second registration information includes a same pool handle as the first registration information and a second pool element identifier, creating a pool that comprises the first pool element and the second pool element, and adopting, for the pool, the received redundancy model. The processor further stores in the at least one memory device the pool handle in association with first pool element identifier, the second pool element identifier, and the redundancy model.

Yet another embodiment of the present invention encompasses, in an Internet Protocol-based communication system comprising an End-Point Name Resolution Protocol (ENRP) server, a communication device capable of retrieving a transport address from the ENRP server. The communication device includes a processor coupled to at least one memory device. The processor assembles a data packet intended for a pool handle, requests a translation of the pool handle from the ENRP server, in response to the request receives multiple transport addresses and at least one of a load-sharing policy and a redundancy model corresponding to the pool handle, stores the received multiple transport addresses and the received at least one of a load-sharing policy and a redundancy model in the at least one memory device, selects a transport address from among the multiple transport addresses to produce a selected transport address, and conveys the data packet to the selected transport address.

Still another embodiment of the present invention encompasses a communication device capable of operating in an Internet Protocol-based communication system. The communication device includes at least one memory device that stores transport addresses and service statuses associated with each pool element of multiple pool elements in a pool and a redundancy model associated with the pool. The communication device further includes a processor coupled to the at least one memory device that detects a transport failure in regard to a communication with a pool element of the multiple pool elements, determines a backup pool element based on a designation of a backup pool element from among the multiple pool elements, determines, with reference to the at least one memory device, a service status of the designated backup pool element, subsequent to the detection of the transport failure and when the designated backup pool element is in-service, conveys data packets to the designated backup pool element, and subsequent to the detection of the transport failure and when the designated backup pool element is out-of-service, determines, with reference to the at least one memory device, a backup pool element based on a redundancy model and conveying data packets to the backup pool element that is determined based on the redundancy model.

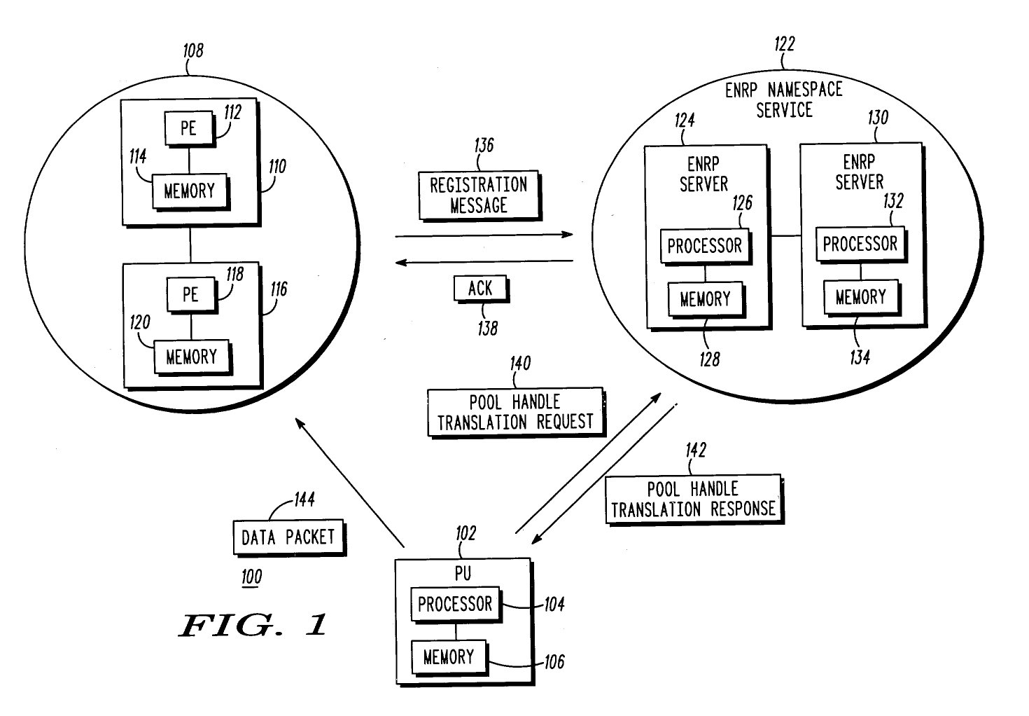

The present invention may be more fully described with reference to FIGS. 1-8. FIG. 1 is a block diagram of an Internet Protocol (IP) communication system 100 in accordance with an embodiment of the present invention. Communication system 100 includes at least one pool user (PU) 102, that is, a client communication device, such as a telephone or data terminal equipment such as a personal computer, laptop computer, or workstation and multiple host communication devices 110, 116, (two shown) such as computers, workstations, or servers, that run applications accessed by the PU. An application running on PU 102 exchanges data packets with an application running on each of one or more host communication devices 110, 116. However, the lower level protocol layers of the one or more host communication devices 110, 116 are transparent to the application layer of PU 102, with the result that the one or more host communication devices 110, 116 appear as a single host to the application layer of the PU. In an IP environment, PU 102 may further be a wireless communication device, such as a cellular telephone, a radiotelephone, or a wireless modem coupled to or included in data terminal equipment, such a personal computer, laptop computer, or workstation.

Each host communication device 110, 116 comprises a respective processing resource, or pool element (PE), 112, 118 of a pool 108. Pool 108 provides application processing services to an application running on PU 102. Each processing resource, or PE, 112, 118 in pool 108 is an application processor that provides a same, specific service to the application and is functionally identical to the other PEs in the pool. While each PE 112, 118 may reside in a host communication device 110, 116 such as a computer or a server such as a web-based server, the specific residence of each PE 112, 118 is not critical to the present invention. Furthermore, communication system 100 does not impose a geographical restriction upon the PEs in a pool, that is, each PE 112, 118 in pool 108 may be freely deployed on any host communication device across communication system 100. However, in another embodiment of the present invention wherein a state sharing mechanism is employed by pool 108, communication system 100 may impose geographical restrictions upon the PEs 112, 118 that belong to the pool. Furthermore, PU 102 may also be a PE of another pool that is communicating with pool 108.

Pool 108 is associated with a load sharing policy that determines an order in which the pool assigns a PE to service a user accessing the pool. For example, when pool 108 is associated with a round-robin load sharing policy and PE 112 has been assigned the most recent user session, if PE 118 is the next PE in the round robin queue then pool 108 assigns PE 118 to service the next user accessing the pool. However, one of ordinary skill in the art realizes that many load sharing policies are known in the art, such as least-used and weighted round robin, any of which may be implemented by pool 108 without departing from the spirit and scope of the present invention. Pool 108 further is associated with a redundancy model that determines a backup PE for an active PE, so that if the active PE crashes then the PU can pick the backup PE that performs the functions that were being performed by the active PE. For example, pool 108 may be associated with an ‘N+1’ redundancy model, wherein ‘N’ active PEs share a node and one PE is set aside as a backup. If one of the ‘N’ PEs crashes, the PU can step in and pick a backup PE to take its place. By way of another example, pool 108 may be associated with an ‘N+M’ redundancy model, wherein ‘N’ active PEs share a node and ‘M’ PEs are set aside as backups. By way of yet another example, pool 108 may be associated with an ‘M pair’ redundancy model, wherein ‘2×M’ PEs are paired up into ‘M’ pairs, each pair comprising an active and a backup PE. If an active PE crashes, then the PU switches to the backup PE of the pair. If the backup PE crashes, it is not replaced. One of ordinary skill in the art realizes there are a variety of redundancy models, any of which may be implemented by pool 108 without departing from the spirit and scope of the present invention.

Communication system 100 further includes an End-Point Name Resolution Protocol (ENRP) namespace service 122 that is in communication with each PE 112, 118 of pool 108. ENRP namespace service 122 may comprise a single ENRP server or may comprise a pool of multiple, fully distributed ENRP servers 124, 130 (two shown). By comprising a pool of ENRP servers, ENRP namespace service 122 can provide high availability service, that is, service with no single point of failure. When ENRP namespace service 122 includes multiple ENRP servers, each of the multiple ENRP servers 124, 130 is in communication with the other ENRP servers of the namespace service and communicates with the other ENRP servers by use of the ENRP protocol.

Each of PU 102 and the one or more ENRP servers 124, 130 in ENRP namespace service 122 includes a respective processor 104, 126, 132, such as one or more microprocessors, microcontrollers, digital signal processors (DSPs), combinations thereof or such other devices known to those having ordinary skill in the art. Each of components 102, 112, 118, 124, and 130 further includes, or is associated with, one or more respective memory devices 106, 114, 120, 128, and 134, such as random access memory (RAM), dynamic random access memory (DRAM), and/or read only memory (ROM) or equivalents thereof, that store data and programs that may be executed by the component's processor.

Communication system 100 is an IP-based communication system that operates in accordance with the Internet Engineering Task Force (IETF) Reliable Server Pooling (RSERPOOL) protocol suite, IETF RFC (Request For Comments) 3237, subject to modifications to the protocols provided herein, which protocols are hereby incorporated by reference herein. The IETF RSERPOOL protocol suite provides for cluster, or pool, management in an IP-based network and can be obtained from the IETF at the IETF offices in Reston, Va., or on-line at ietf.org/rfc.

At the level of interconnected networks systems, such as system 100, understandings known as protocols have been developed for an exchange of data among multiple users of the networks. The protocols specify the manner of interpreting every data bit of a data packet exchanged across the networks. In order to simplify network designs, several well-known techniques of layering the protocols have been developed. Protocol layering divides the network design into functional layers and then assigns separate protocols to perform each layer's task. By using protocol layering, the protocols are kept simple, each with a few well-defined tasks. The protocols can then be assembled into a useful whole, and individual protocols can be removed or replaced as needed.

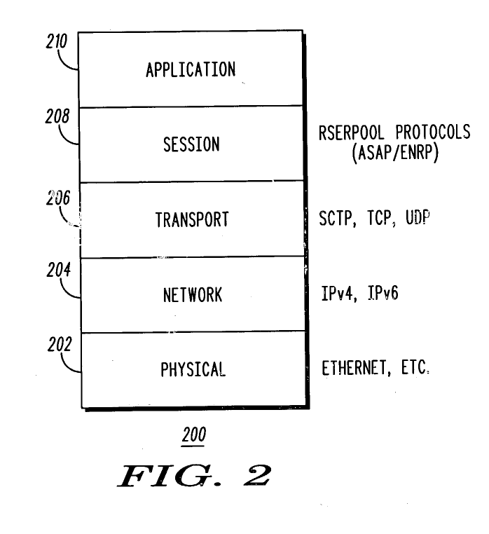

A layered representation of protocols is commonly known as a protocol stack. FIG. 2 is a block diagram of a protocol stack 200 implemented in each component of communication system 100, that is, PU 102, PEs 112 and 118, and ENRP servers 124 and 130. The protocol stack includes five layers, which layers are, from highest to lowest, an application layer 210, a session layer 208, a transport layer 206, a network layer 204, and a physical layer 202. Each layer of the protocol stack, other then the physical layer, is implemented in the processor of each component and operates based on instructions stored in the corresponding memory devices.

The bottom layer of protocol stack 200, that is, physical layer 202, includes the network hardware and a physical medium, such as an ethernet, for the transportation of data. The next layer up, that is, network layer 204, is responsible for delivering data across a series of different physical networks that interconnect a source of the data and a destination for the data. Routing protocols, for example, IP protocols such as IPv4 or IPv6, are included in the network layer. An IP data packet exchanged between peer network layers includes an IP header containing information for the IP protocol and data for the higher level protocols. The IP header includes a Protocol Identification field and further includes transport addresses, typically IP addresses, corresponding to each of a transport layer sourcing the data packet and a transport layer destination of the data packet. An transport address uniquely identifies an interface that is capable of sending and receiving data packets to transport layers via the network layer and is described in detail in IETF RFC 1246, another publication of the IETF. The IP Protocol is defined in detail in IETF RFC 791.

The next layer up from network layer 204 is transport layer 206. Transport layer 206 provides end-to-end data flow management across interconnected network systems, such as connection rendezvous and flow control. Typically, the transport layer includes one of multiple transport protocols, such as SCTP (Stream Control Transmission Protocol), TCP (Transmission Control Protocol), or UDP (User Datagram Protocol), that each provides a mechanism for delivering network layer data packet to a specified port. Above transport layer 206 is session layer 208. Session layer 208 implements RSERPOOL protocols, such as ASAP (Aggregate Server Access Protocol) and ENRP, and is the layer at which RSERPOOL signaling is exchanged among the components 102, 112, 118, 124, and 130 of communication system 100. The ASAP and ENRP protocols are described in IETF Internet-Draft papers ‘draft-ietf-rserpool-asap-05,’ dated Oct. 31, 2002, and ‘draft-ietf-rserpool-common-param-02,’ dated Oct. 1, 2002, which papers are publications of the IETF and are hereby incorporated by reference herein in their entirety. Above session layer 208 is application layer 210, which layer contains protocols that implement user-level applications, such as file transfer and mail delivery.

In order to support an implementation of multiple redundancy models and to further support a dynamic implementation of redundancy models, communication system 100 provides a pool element registration process and a corresponding pool creation process that supports implementation, by the pool, of any one of multiple redundancy models. Furthermore, since a load sharing policy and redundancy model/fail-over policy of the pool may not be predetermined and can be established upon creation of the pool, communication system 100 supports a dynamic implementation of redundancy models. In addition, in communication system 100, a PU accessing a pool is able to select a destination PE, or a backup PE for a failed PE, based on the redundancy model/fail-over policy of the pool, thereby providing greater flexibility to the system.

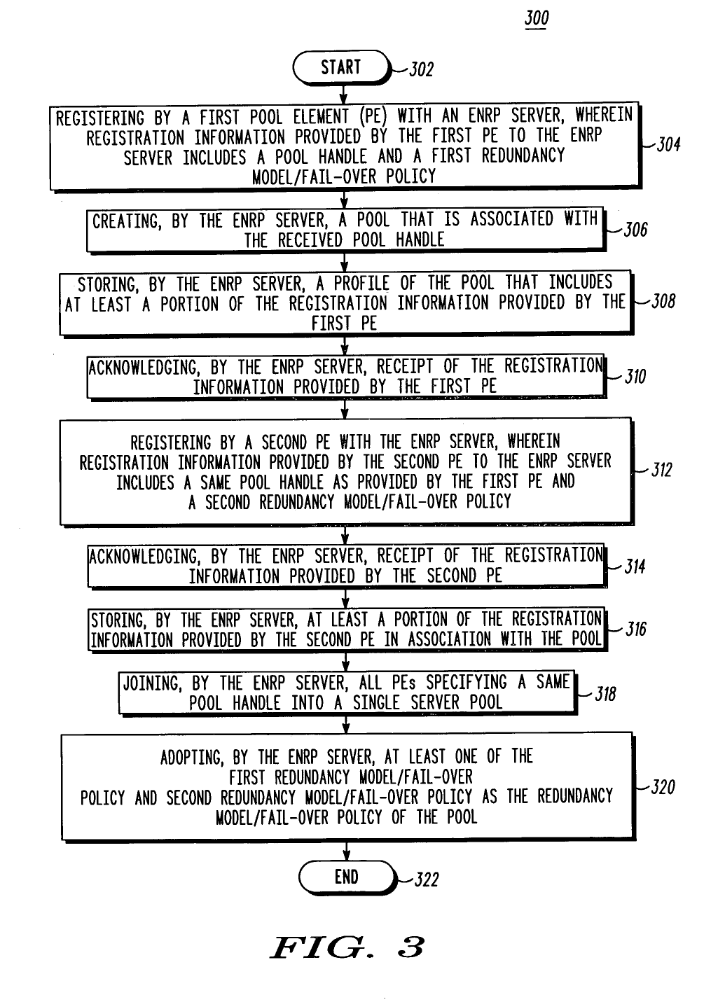

FIG. 3 is a logic flow diagram 300 of a pool element registration process in accordance with an embodiment of the present invention. Logic flow diagram 300 begins (302) when a first PE, such as PE 112, registers (304) with ENRP namespace service 122, and in particular with a home ENRP server, such as ENRP server 124, included in the ENRP namespace service. Typically, a PE has only one home ENRP server at any given time, which home ENRP server is the ENRP server providing services to the PE at that time. In one embodiment of the present invention, a transport address of the home ENRP server may be manually stored in each PE's 112, 118 respective memory devices 114, 120. In another embodiment of the present invention, each PE 112, 118 may auto-discover the transport address of a home ENRP server, such as ENRP server 124, by conveying a service request over a multicast channel to each of one or more ENRP servers 124, 130 in ENRP namespace service 122. When the PE receives a response from more than one ENRP servers, the PE may select one of the more than one ENRP servers to serve as the PE's home ENRP server and stores the corresponding transport address in the PE's memory devices.

PE 112 registers by conveying a session layer 208 registration message 136 to the home ENRP server. Registration message 136 includes a pool handle, that is, a pool name, such as “rnc_cp_pool,” that the registering PE, that is, PE 112, wishes to register with ENRP namespace service 122. Registration message 136 further includes a PE identifier associated with the registering PE. The PE identifier includes the transport layer protocols and transport addresses, such as an IP address and port number, associated with the PE. Registration message 136 further informs of a load sharing policy and redundancy model/fail-over policy preferred by the PE, a role of the PE, that is, whether the PE is an active PE, a standby PE, both an active and a standby PE, or a PE of undefined role, and a service state of the PE, that is, whether the PE is ‘in-service’ or ‘out-of-service.’ In addition, registration message 136 may further include a ‘weight’ or a ‘node index’ associated with the PE and a backup PE identifier that informs whether the PE has one or more backup PEs and/or identifies the one or more backup PEs. The weight or node index associated with each PE in a pool may then be used by a PU accessing the pool to determine which PE of multiple PEs to access when accessing the pool, or to determine which PE of multiple PEs to access when a PE servicing the PU fails.

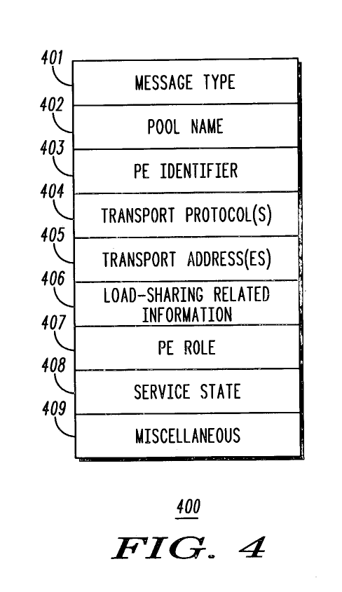

For example, FIG. 4 is a block diagram of an exemplary registration message 400 in accordance with an embodiment of the present invention. Registration message 400 includes multiple data fields 401-409 comprising registration information. A first data field 401 of the multiple data fields 401-409 informs of a message type, that is, that the message is a policy message. Data field 401 may further identify the message as a registration message. A second data field 402 of the multiple data fields 401-409 identifies the pool to which the PE belongs by providing an application layer 210 pool name, that is, a pool handle, such as “rnc_cp_pool,” that is uniquely associated with the PE's pool, that is, pool 108. A third data field 403 of the multiple data fields 401-409 provides a PE identifier, such as a tag associated with the PE. A fourth data field 404 of the multiple data fields 401-409 identifies one or more transport protocols that the PE is willing to support, such as SCTP. A fifth data field 405 of the multiple data fields 401-409 provides a transport address, such as an IP address and port number, for accessing a particular application at the PE. A sixth data field 406 of the multiple data fields 401-409 provides load sharing-related information, such as a load sharing policy and/or a redundancy model/fail-over policy. A seventh data field 407 of the multiple data fields 401-409 informs of a role of the PE, that is, whether the PE is an active PE, a standby PE, both an active PE and a standby PE, or a PE of undefined role. An eighth data field 408 of the multiple data fields 401-409 informs of a service state of the PE, that is, whether the PE is in-service or out-of-service. In addition, registration message 136 may further include one or more data fields 409 that inform of whether the PE has one or more backup PEs and/or identifies the one or more backup PEs, informs of a ‘weight’ or a ‘node index’ associated with the PE, and provides other information related to the operation of the PE in the pool, such as a registration lifetime, that is, a quantity of time that the registration is good for, a load capacity of the PE, and a load factor, such as a weight or node index, associated with the PE and a load sharing policy and/or redundancy model/fail-over policy that may be applied to the PE.

Upon receiving the registration information from PE 112, ENRP server 124 creates (306) a pool, that is, pool 108, corresponding to the received pool handle. In creating the pool, ENRP server 124, preferably processor 126 of the ENRP server, stores (308) a profile of pool 108 in the server's memory devices 128. The profile of pool 108 comprises the registration information conveyed by PE 112 to the ENRP server, including the pool handle, the PE identifier of PE 112, the PE's role and service status, the PE's transport address(es) and transport protocols, the load sharing policy and the redundancy model/fail-over policy provided by the PE, and the additional information, such as any backup PEs, provided by the registering PE. In addition, upon successfully receiving registration message 136 from PE 112, ENRP server 124, preferably processor 126, acknowledges (310) the message, preferably by conveying a registration acknowledgment 138 to the PE.

In order to provide a backup system for home ENRP server 124 assigned to pool 108, ENRP namespace service 122 distributes the profile of pool 108 among all of the servers 124, 130 included in the ENRP namespace service. In one embodiment of the present invention, ENRP namespace service 122 may distribute the pool profile information upon the initial setting up of pool 108. ENRP namespace service 122 may subsequently distribute additional pool profile information each time a PE registers, deregisters, or re-registers with pool 108. In another embodiment of the present invention, ENRP namespace service 122 may provide for intermittent updates of pool profile information. For example, each of the one or more servers 124, 130 of ENRP namespace service 122 may intermittently cross-audit the other servers, during which cross-audits each server updates the other servers with respect to registration, deregistration, and re-registration of PEs and PUs serviced by the server. As a result, each of the one or more ENRP servers 124, 130 in ENRP namespace service 122 maintains, in the respective memory devices 128, 134 of the server, a complete copy of a namespace, that is, a complete record of registration information for each PE 112, 118 included in the pool, that is, pool 108, serviced by the namespace service.

Upon receiving (312) at least a second registration message 136 from at least a second PE, such as PE 118, of the multiple PEs 112, 118, ENRP server 124, preferably processor 126, acknowledges (314) the at least a second PE's registration message 136. When the at least a second registration message 136 received from the at least a second PE 118 specifies a same pool handle as is specified by first PE 112, processor 126 also stores (316), in the profile of pool 108 maintained in memory devices 128 of server 124 and in associastion with the registering PE, the registration information provided by the at least a second PE. Processor 126 of ENRP server 124 further joins (318) each PE specifying a same pool handle, that is PEs 112, 118, into a single server pool, that is, pool 108.

In one embodiment of the present invention, processor 126 of ENRP server 124 adopts (320) the redundancy model/fail-over policy of the first registering PE, that is, PE 112, as the redundancy model/fail-over policy of the corresponding pool, that is, pool 108. Such model/policy may be adopted as the pool model/policy at the time of the registration of first PE 112. However, in another embodiment of the present invention, the ENRP server 124 may adopt, for pool 108, a redundancy model/fail-over policy of any PE 112, 118 registering as part of the pool, so along as a same redundancy model/fail-over policy is implemented throughout the pool. Logic flow 300 then ends (322). Each PE 112, 118 in pool 108 is considered functionally identical to the other PEs in the pool. However, each PE in pool 108 may declare, in the PE's respective registration message 136, a different load capacity than the other PEs in the pool.

Communication system 100 also permits a dynamic modification of pools. When a PE 112, 118 desires to exit pool 108, the PE sends a deregistration message to home ENRP server 124. Deregistration messages are well known in the art and include the pool handle and the PE identifier associated with the PE, thereby allowing the PE's home ENRP server to verify the identity of the deregistering PE. When ENRP server 124 receives the deregistration message, the ENRP server deletes the PE, and the PE's associated registration information, from the profile of the pool. PEs 112, 118 may also update their registration by sending a new registration message to home ENRP server 124. Upon receiving the new registration message, the ENRP server will update the information stored in the pool profile with respect to the PE. For example, in the event that a PE becomes heavily loaded, the PE may update a weight or node index associated with the PE in order to reduce the likelihood that the PE will be assigned additional processing, and then readjust the associated weight or node index when the PE's processing load diminishes.

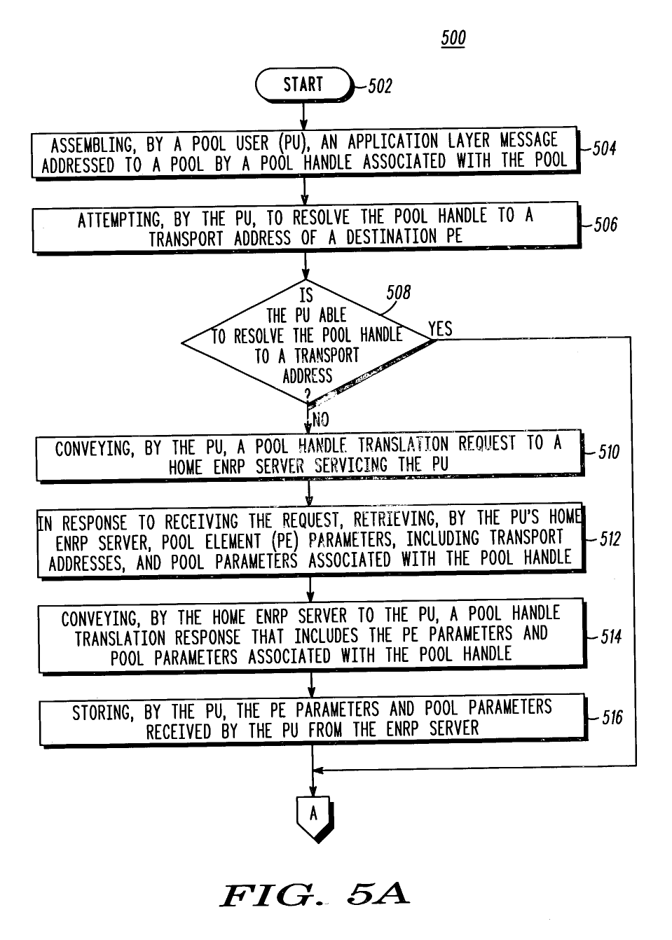

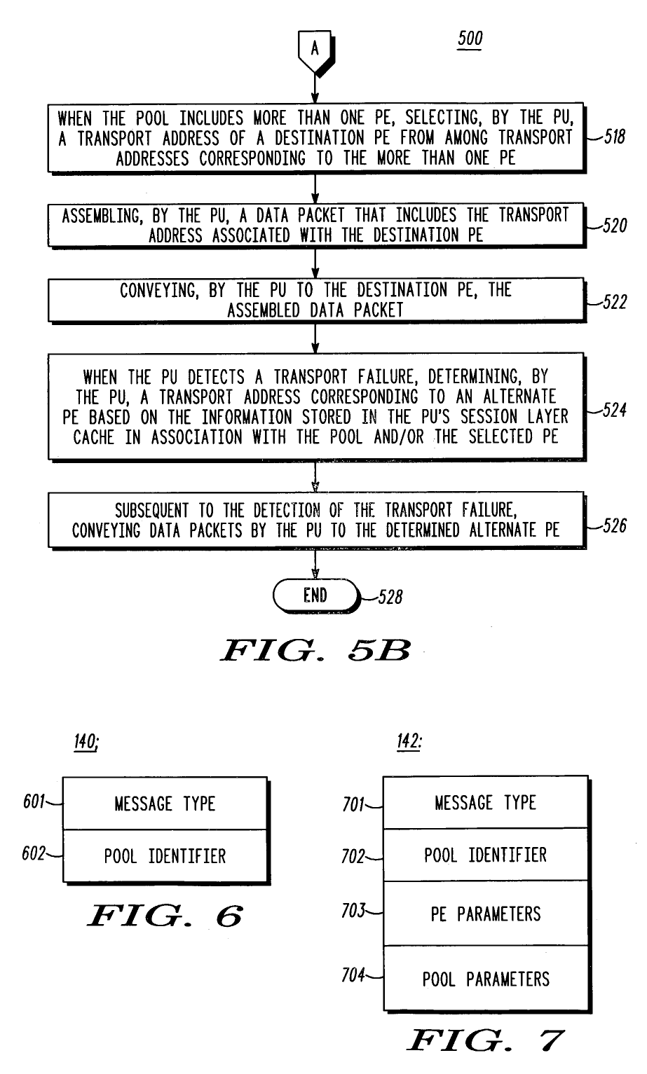

Upon establishment of pool 108, an application running on a PU, such as PU 102, may access services provided by the pool. FIGS. 5A and 5B provide a logic flow diagram 500 of steps by which PU 102 can access services provided by pool 108 in accordance with an embodiment of the present invention. Logic flow diagram 500 begins (502) when an application running on application layer 210 of PU 102 assembles (504) an application layer message that is addressed to pool 108 by the application layer pool handle associated with the pool, such as “rnc_cp_pool.” Session layer 208, preferably ASAP, of PU 102 then attempts to resolve (506) the pool handle to a lower layer transport address, such as an IP address and a port number, of a PE, such as PE 112 or 118, of pool 108 by reference to a session layer cache maintained in the memory devices 106 of the PU.

When PU 102 cannot resolve (508) the pool handle to a transport address, such as an IP address, PU 102, preferably session layer 208 of the PU, requests (510) of ENRP namespace service 122, preferably an ENRP server that is servicing the PU, such as ENRP server 124, a translation of the pool handle to a transport address associated with the pool handle. PU 102 may be programmed with the address of the ENRP server or may obtain the address through a known ENRP discovery mechanism. For example, when the session layer 208 of PU 102 is accessing pool 108 for the first time, PU 102 may not have a record of a lower layer transport address associated with the pool handle of pool 108. In such an instance, PU 102 may not be able to retrieve, from the memory devices 106 of the PU, a transport address associated with the pool handle. Referring now to FIG. 6, a block diagram of a pool handle translation request 140 conveyed by PU 102 to ENRP server 124 is illustrated in accordance with an embodiment of the present invention. Pool handle translation request 140 comprises a data packet, preferably a name resolution message, that includes multiple data fields 601, 602. A first data field 601 of the multiple data fields 601, 602 informs of a message type, that is, that the message is a transport address query such as a name request message. A second data field 602 of the multiple data fields 601, 602 provides the pool handle, such as “rnc_cp_pool.”

Referring now to FIGS. 1, 5A, 5B, and 7, upon receiving pool handle translation request 140 from PU 102, the ENRP server servicing the PU, that is, ENRP server 124, retrieves (512) pool parameters and PE parameters associated with the received pool handle from the memory devices 128 of the server and conveys (514) the retrieved information in a pool handle translation response 142 to requester PU 102. FIG. 7 is a block diagram of pool handle translation response 142 in accordance with an embodiment of the present invention. Pool handle translation response 142 comprises a data packet, preferably a modified version of a name resolution response message of the prior art, that includes multiple data fields 701-704. A first data field 701 of the multiple data fields 701-704 informs of a message type, that is, that the message is a pool handle translation response. A second data field 702 of the multiple data fields 701-704 provides the pool handle associated with pool handle translation request 140, such as “rnc_cp_pool.” A third data field 703 of the multiple data fields 701-704 provides parameters corresponding to each of the PEs, that is, PE 112 and 118, included in the pool, that is, pool 108, associated with the pool handle. The parameters provided with respect to each PE include a lower layer transport address associated with the PE, such as an IP address and port number in an IP-based system, and a role and service status associated with the PE. Preferably, the PE parameters further include one or more load factors, and any additional registration information associated with the PE, such as a list of one or more backup PEs. A fourth data field 704 of the multiple data fields 701-704 provides pool parameters associated with the pool, such as load sharing-related information such as a load sharing policy and a redundancy model/fail-over policy.

Upon receiving pool handle translation response 142 from ENRP server 124, PU 102 stores (516) the information included in the pool handle translation response in the session layer cache in the memory devices 106 of the PU. Preferably, PU 102 creates a table associated with pool 108, which table includes each PE 112, 118 in the pool 108 and further includes, in association with each PE, the PE parameters provided with respect to the PE, such as the transport address of the PE, the role and service status of the PE, and any load factors associated with the PE. PU 102 further stores in the cache and in association with pool 108 the pool parameters provided with respect to the pool, including the load sharing-related information, that is, the pool's load sharing policy and redundancy model/fail-over policy. When session layer 208 of PU 102 receives subsequent messages from the application layer of the PU that are addressed to the same pool handle, the session layer (i.e., ASAP) is able to route the messages to an appropriate PE without again querying ENRP server 124. That is, when PU 102 subsequently accesses pool 108, session layer 208 of the PU selects a destination PE 112, 118 by reference to the PU's session layer cache and based on the load sharing policy associated with the pool and load factors, if any, associated with each PE 112, 118 in the pool. For example, if pool 108 implements a round robin load sharing policy and PU 102 last communicated with PE 112, PU 102 may pick a PE, such as PE 118, that is listed next in the table stored in the PU's session layer cache or that has a next node index number. By way of another example, if pool 108 implements a weighted round robin load sharing policy and PU 102 last communicated with PE 112, PU 102 may pick a PE in pool 108 other than PE 112 that has a lowest assigned weight based on the weights stored in the PU's session layer cache in association with each PE.

In another embodiment of the present invention, the information provided to PU 102 by pool handle translation response 142 may be programmed into PU 102, and stored in the PU's session layer cache, prior to the PU's first attempt to access pool 108. In such an embodiment, each time, including the first time, the PU attempts to access pool 108, session layer 208 of the PU may select a destination PE from among the multiple PEs 112, 118 of the pool by reference to the PU's session layer cache and based on the load sharing policy associated with pool 108 and load factors associated with each PE 112, 118.

In order to minimize an amount of memory allocated to the session layer cache in PU 102, the information stored in the session layer cache may time-out upon expiration of a time-out period. Upon timing-out, the information is cleared out of the cache. However, the time-out period and the clearing out of the cache are up to the designer of the PU and are not critical to the present invention.

Upon determining a lower layer transport address for a routing of the message, session layer 208 of PU 102 assembles (520) a data packet 144 that is routed to a destination PE in pool 108 via the determined transport address. As noted above, when pool 102 includes multiple PEs, such as PEs 112 and 118, PU 102, and in particular session layer 208 of the PU, may select (518) a transport address of a destination PE, such as an IP address and port number associated with PE 112, from among the transport addresses corresponding to each of the multiple PEs 112, 118 based on the load sharing policy of pool 108 and the load factor of each such PE 112, 118. PU 102, and in particular session layer 208 of the PU, then embeds in data packet 144 the transport address of the destination PE and information concerning transport protocols supported by the PU. PU 102 then conveys (522) data packet 144 to the selected PE 112 via the embedded transport address.

When PU 102 detects a transport failure, for example, one or more data packets are not acknowledged by the PE, transport layer 206 of the PU notifies session layer 208 of the PU of a transport layer failure. Upon receiving the failure notification, session layer 208 of PU 102 determines (524) a transport address of an alternate PE, such as PE 118, of pool 108 based on the information stored in association with PE 112 and/or pool 108 in the session layer cache of PU 102. PU 102, and in particular session layer 208 of the PU, then subsequently conveys (526) data packets to the determined alternate PE in a manner that is transparent to the application running on application layer 210 of the PU, and the logic flow ends (528). However, the application running on PU 102 may specify rules of how and when to fail-over, to force a rollover, or to disable fail-over all together. Also, the application running on PU 102 may define the start and end of a communication session and can do load sharing and fail-over on a per session basis.

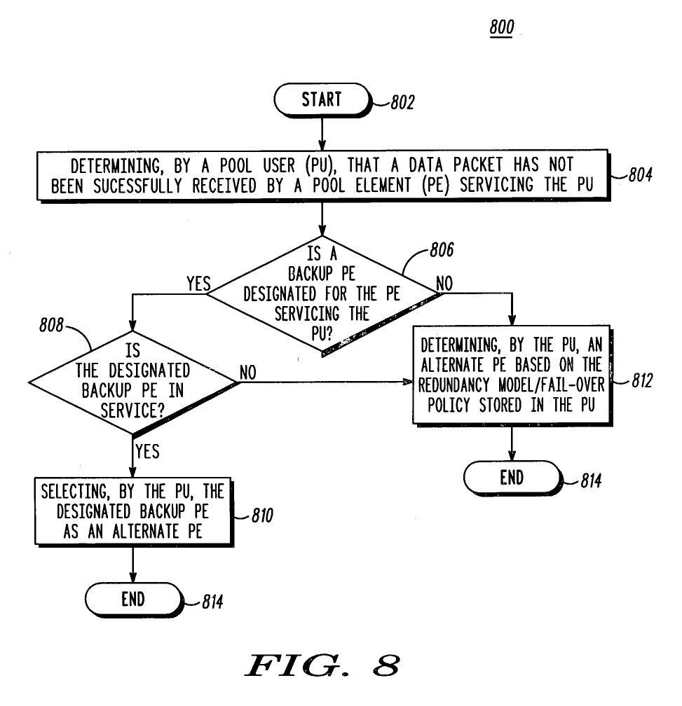

FIG. 8 is a logic flow diagram 800 of steps executed by PU 102, preferably by session layer 208 of PU 102, in determining a transport address of an alternate PE in accordance with an embodiment of the present invention. Logic flow 800 begins (802) when PU 102 determines (804) that a packet has not been successfully received by a destination PE, that is, PE 112. PU 102 then determines (806), by reference to the session layer cache stored in the memory devices 106 of the PU, whether a backup PE, such as PE 118, has been designated for the PE that was servicing the PU, that is, PE 112. When a backup PE has been designated for the failing PE, that is, PE 112, the PU then determines (808) if the designated backup PE is ‘in-service.’ If the designated backup PE is ‘in-service,’ PU 102 then selects (810) the designated backup PE as the alternate PE and the logic flow ends (814). Preferably, PU 102 selects the designated backup PE as the alternate PE regardless of the role stored in the PU's session layer cache in association with the backup PE. However, in another embodiment of the present invention, the PU selects the designated backup PE as the alternate PE if the information stored in the PU's cache in regard to the alternate PE indicates that the PE's role is either ‘standby’ or ‘both active and standby.’

If the session layer cache of PU 102 does not include a designated backup PE for the failing PE, that is, PE 112, or the designated backup PE or PEs are not ‘in-service’ or cannot be determined to be ‘in-service,’ then PU 102 determines (812) an alternate PE by reference to the session layer cache and the logic flow ends (814). Preferably, in order to qualify as an alternate PE, the information stored in the PU's cache in regard to the PE indicates that the PE's role is either ‘standby’ or ‘both active and standby,’ that is, dual, and the service state of the alternate PE is ‘in-service.’ When more than one PE in pool 108 qualifies as an alternate PE under these criteria, PU 102 determines (812) an alternate PE from among the multiple qualifying PEs by utilizing the redundancy model/fail-over policy stored in the cache in regard to pool 108. However, in another embodiment of the present invention, PU 102, in selecting an alternate PE, may ignore the designations of backup PEs and select an alternate PE based on the redundancy model/fail-over policy stored in the PU's session layer cache.

In summarizing, an Internet Protocol-based communication system 100 is provided wherein an ENRP server 124 receives registration information from each of a first pool element PE 112 and a second PE 118. The registration information received from each PE 112, 118 includes a pool handle and transport layer protocols and transport addresses, such as an IP address and port number, associated with the PE, and informs of a load sharing policy and redundancy model/fail-over policy preferred by the PE, a role of the PE, that is, whether the PE is an active PE, a standby PE, both an active and a standby PE, or a PE of undefined role, and a service state of the PE, that is, whether the PE is ‘in-service’ or ‘out-of-service.’ The registration information may further include a ‘weight’ or a ‘node index’ associated with the PE and a backup PE identifier that informs whether the PE has one or more backup PEs and/or identifies the one or more backup PEs. The weight or node index associated with each PE in a pool may then be used by a PU accessing the pool to determine which PE of the multiple PEs 112, 118 to access when accessing the pool, or to determine which PE of the multiple PEs to access when a PE servicing the PU fails. ENRP server 124 creates a pool 108 that includes each of the multiple PEs 112, 118 when each PE provides a same pool handle, and adopts, for the pool, a redundancy model provided by a PE of the multiple PEs.

A PU 102 may then access pool 108 by assembling a data packet intended for the pool handle associated with the pool and requesting a translation of the pool handle from ENRP server 124 or any other server in ENRP namespace service 122. In response to the request, PU 102 receives PE parameters associated with each PE 112, 118 in pool 108, such as transport addresses, PE roles, PE service statuses, and PE load factors, corresponding to each PE 112, 118 in pool 108 and further receives pool parameters that includes a redundancy model/fail-over policy adopted for the pool. PU 102 stores, in a session layer cache, the received PE parameters and pool parameters in association with pool 108. When PU 102 is in communication with a PE of pool 108 and detects a transport failure, the PU selects a transport address of an alternate PE based on PE parameters and the pool's adopted redundancy model/fail-over policy and subsequently conveys data packets to the selected alternate PE.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for pooling resources in an Internet Protocol-based communication system comprising:
receiving first registration information from a first pool element, wherein the registration information comprises a pool handle and a redundancy model;
receiving second registration information from a second pool element, wherein the second registration information comprises a same pool handle as the first registration information; and
creating a pool that comprises the first pool element and the second pool element, wherein the creating of the pool comprises adopting, for the pool, the received redundancy model.

2. The method of claim 1 further comprising acknowledging receipt of each of the first registration information and the second registration information.

3. The method of claim 1 wherein the first registration information further comprises a first pool element identifier, wherein the second registration information further comprises a second pool element identifier, and wherein the method further comprises storing, in association with the pool handle, at least a portion of the first registration information, at least a portion of the second registration information, and the redundancy model.

4. The method of claim 1, wherein the first registration information is received in a first session layer registration message and the second registration information is received in a second session layer registration message.

5. The method of claim 1, wherein the first registration information further comprises a first service state of the first pool element and the second registration information further comprises a second service state of the second pool element.

6. The method of claim 1, wherein the first registration information further comprises a first role of the first pool element and the second registration information further comprises a second role of the second pool element.

7. A method for accessing pooled resources in an Internet Protocol-based communication system comprising:
assembling a data packet intended for a pool handle;
requesting a translation of the pool handle from a name server;
in response to the request, receiving a plurality of transport addresses and a redundancy model corresponding to the pool handle;
storing the received plurality of transport addresses and the received redundancy model;
selecting a transport address from among the plurality of transport addresses to produce a selected transport address; and
conveying the data packet to the selected transport address.

8. The method of claim 7 wherein assembling comprises assembling, by an application layer of a pool user, a data packet intended for a pool handle and wherein requesting comprises:
attempting, by a session layer of the pool user, to resolve the pool handle to a transport address;
when the session layer is unable to resolve the pool handle to a transport address, requesting, by the session layer of a name server, a translation of the pool handle.

9. The method of claim 7 wherein receiving comprises receiving a plurality of transport addresses and a load-sharing policy corresponding to the pool handle, wherein the data packet comprises a first data packet, wherein the selected transport address comprises a first transport address, and wherein the method further comprises:
assembling a second data packet intended for the pool handle;
determining a second transport address of the plurality of transport addresses based on the load sharing policy; and
conveying the second data packet to the second transport address.

10. The method of claim 7, wherein receiving comprises receiving a plurality of transport addresses and a redundancy model corresponding to the pool handle, wherein the data packet comprises at least a first data packet, wherein the selected transport address comprises a first transport address, and wherein the method further comprises:
determining that a data packet of the at least a first data packet has not been successfully received at the data packet's intended destination;
determining a second transport address of the plurality of transport addresses based on the redundancy model; and
reconveying the not successfyully received data packet to the second transport address.

11. The method of claim 7, wherein the data packet comprises at least a first data packet and wherein the method further comprises:
receiving, from a pool element associated with the selected transport address, a designation of at least one backup pool element;
detecting a transport failure;
determining a backup pool element based on the designation of at least one backup pool element; and
subsequent to the detection of the transport failure, conveying data packets to the determined backup pool element.

12. The method of claim 11, wherein receiving a plurality of transport addresses and a redundancy model comprises receiving a plurality of transport addresses and a redundancy model corresponding to the pool handle, wherein receiving a designation of at least one backup pool element comprises receiving, from a pool element associated with the selected transport address, a designation of at least one backup pool element from among a plurality of pool elements, and wherein the method further comprises:
in response to the request for a translation of the pool handle, receiving a service status of each pool element of the plurality of pool elements;
storing the received service statuses in association with the corresponding pool elements;
determining a designated backup pool element based on the designation of at least one backup pool element;
determining a service status of the designated backup pool element based on the designation of at least one backup pool element and by reference to the stored service statuses;
subsequent to the detection of the transport failure and when the designated backup pool element is in-service, conveying data packets to the designated backup pool element; and
subsequent to the detection of the transport failure and when the designated backup pool element is out-of-service, determining a backup pool element based on the redundancy model and conveying data packets to the backup pool element determined based on the redundancy model.

13. A method for determining an alternate pool element from among a plurality of pool elements, the method comprising:
detecting a transport failure in regard to a communication with a pool element of the plurality of pool elements;
determining a backup pool element based on a designation of a backup pool element from among the plurality of pool elements;
determining a service status of the designated backup pool element;
subsequent to the detection of the transport failure and when the designated backup pool element is in-service, conveying data packets to the designated backup pool element; and
subsequent to the detection of the transport failure and when the designated backup pool element is out-of-service, determining a backup pool element based on a redundancy model and conveying data packets to the backup pool element that is determined based on the redundancy model.

14. A name server capable of operating in an Internet Protocol-based communication system comprising:
a processor that is capable of receiving first registration information from a first pool element, wherein the registration information comprises a pool handle, a first pool element identifier, and a redundancy model, receiving second registration information from a second pool element, wherein the second registration information comprises a same pool handle as the first registration information and a second pool element identifier, creating a pool that comprises the first pool element and the second pool element, and adopting, for the pool, the redundancy model; and
at least one memory device coupled to the processor, wherein the processor stores in the at least one memory device the pool handle in association with first pool element identifier, the second pool element identifier, and the redundancy model.

15. The name server of claim 14, wherein the processor further acknowledges receipt of each of the first registration information and the second registration information.

16. The name server of claim 14, wherein the processor implements a plurality of protocol layers, wherein the plurality of protocol layers comprises a session layer that is implemented between a transport layer and an application layer, wherein the first registration information is received in a first session layer registration message, and wherein the second registration information is received in a second session layer registration message.

17. The name server of claim 14, wherein the first registration information further comprises a first service state of the first pool element, wherein the second registration information further comprises a second service state of the second pool element, and wherein the processor further stores the first service state in the memory in association with the first pool element and stores the second service state in the at least one memory device in association with the second pool element.

18. The name server of claim 14, wherein the first registration information further comprises a first role of the first pool element, wherein the second registration information further comprises a second role of the second pool element, and wherein the processor further stores the first role in the memory in association with the first pool element and stores the second role in the at least one memory device in association with the second pool element.

19. In an Internet Protocol-based communication system comprising an End-Point Name Resolution Protocol (ENRP) server, a communication device capable of retrieving a transport address from the ENRP server, the communication device comprising:
at least one memory device; and
a processor that assembles a data packet intended for a pool handle, requests a translation of the pool handle from the ENRP server, in response to the request receives a plurality of transport addresses and a redundancy model corresponding to the pool handle, stores the received plurality of transport addresses and the received redundancy model in the at least one memory device, selects a transport address from among the plurality of transport addresses to produce a selected transport address, and conveys the data packet to the selected transport address.

20. The communication device of claim 19, wherein the processor implements a plurality of protocol layers, wherein the plurality of protocol layers comprises an application layer, a session layer below the application layer, and a transport layer below the session layer, wherein the application layer assembles the data packet intended for a pool handle, and wherein the session layer attempts to resolve the pool handle to a transport address and, when the session layer is unable to resolve the pool handle to a transport address, requests, of a name server, a translation of the pool handle.

21. The communication device of claim 19, wherein the data packet comprises a first data packet, wherein the selected transport address comprises a first transport address, and wherein the processor further assembles a second data packet intended for the pool handle, determining a second transport address of the plurality of transport addresses by reference to the load sharing policy stored in the at least one memory device, and conveys the second data packet to the second transport address.

22. The communication device of claim 19, wherein the processor receives a plurality of transport addresses and a redundancy model, wherein the data packet comprises at least a first data packet, wherein the selected transport address comprises a first transport address, and wherein the processor further, determines that a data packet of the at least a first data packet has not been successfully received by the pool element associated with the selected transport address, determines a second transport address of the plurality of transport addresses by reference to the redundancy model stored in the at least one memory device and reconveys the not successfully received data packet to the second transport address.

23. The communication device of claim 19, wherein the data packet comprises at least a first data packet and wherein the processor further receives, from a pool element associated with the selected transport address, a designation of at least one backup pool element, stores the designation of the at least one backup pool element in the at least one memory device, detects a transport failure, determines a backup pool element by reference to the designation of at least one backup pool element stored in the at least one memory device, and subsequent to the detection of the transport failure, conveys data packets to the determined backup pool element.

24. The communication device of claim 23, wherein the processor receives, and stores in the at least one memory device, a plurality of transport addresses and a redundancy model corresponding to the pool handle, wherein the processor, in response to the request for a translation of the pool handle, further receives a service status of each pool element of the plurality of pool elements and stores the received service statuses in the at least one memory device in association with the corresponding pool elements, wherein receiving, by the processor, a designation of at least one backup pool element comprises receiving, by the processor from a pool element associated with the selected transport address, a designation of at least one backup pool element from among a plurality of pool elements, and wherein the processor further determines a designated backup pool element based on the designation of at least one backup pool element, determines a service status of the designated backup pool element by reference to the at least one memory device, subsequent to the detection of the transport failure and when the designated backup pool element is in-service, conveys data packets to the designated backup pool element, and subsequent to the detection of the transport failure and when the designated backup pool element is out-of-service, determines a backup pool element based on the stored redundancy model and conveys data packets to the backup pool element determined based on the redundancy model.

25. A communication device capable of operating in an Internet Protocol-based communication system, the communication device comprising:
at least one memory device that stores transport addresses and service statuses associated with each pool element of a plurality of pool elements in a pool and a redundancy model associated with the pool; and
a processor coupled to the at least one memory device that detects a transport failure in regard to a communication with a pool element of the plurality of pool elements, determines a backup pool element based on a designation of a backup pool element from among the plurality of pool elements, determines, with reference to the at least one memory device, a service status of the designated backup pool element, subsequent to the detection of the transport failure and when the designated backup pool element is in-service, conveys data packets to the designated backup pool element, and subsequent to the detection of the transport failure and when the designated backup pool element is out-of-service, determines, with reference to the at least one memory device, a backup pool element based on a redundancy model and conveying data packets to the backup pool element that is determined based on the redundancy model.
